(19) United States
(12) Patent Application Publication
(10) Pub. No.: US 2025/0110872 A1
(43) Pub. Date: Apr. 3, 2025

(54) SYSTEMS AND METHODS FOR DEMAND-BASED CONTENT CACHING

(71) Applicant: T-Mobile USA, Inc., Bellevue, WA (US)

(72) Inventors: Paul Bongaarts, Issaquah, WA (US); Herkole Sava, Centerville, VA (US); Michael Scott Witherell, Portland, OR (US)

(21) Appl. No.: 18/374,690

(22) Filed: Sep. 29, 2023

(51) Int. Cl. G06F 12/0802; H04L 67/568

(52) U.S. Cl. CPC G06F 12/0802; H04L 67/568; G06F 2212/154

(57) ABSTRACT

Systems and methods for allocating cache resources on a premises terminal device based on cache allocation performance data are described. Cache resources on a premises terminal device are allocated to cache allocation entities (e.g., providers and/or user accounts) according to various parameters. A cache allocation factor may be determined based on the use of the associated cache resources over time, with allocations being reconfigured periodically based on the cache allocation factor. A cache allocation factor may be based on cache access hit rates, use of requested download windows, and the meeting of requested download deadlines.

### BACKGROUND

As Internet access and technology have improved, the consumption of content via the Internet has grown exponentially. The use of content distribution services, such as television and movie streaming services and video game distribution services, to provide content to user devices continues to grow as more bandwidth becomes available to the average consumer at increasingly lower costs. However, the resources available to provide content to a user are not unlimited. It may be challenging for a network provider to ensure that sufficient resources are provided for a wide variety of users requesting content from a variety of sources.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a schematic diagram of an illustrative communications network environment in which systems and methods for demand-based content caching may be implemented, in accordance with examples of the disclosure.

FIG. 2A is a schematic diagram of illustrative components, communications, and data structures that may be implemented in a communications network in which systems and methods for demand-based content caching may be implemented, in accordance with examples of the disclosure.

FIG. 2B is a schematic diagram of updated illustrative components, communications, and data structures of FIG. 2A that may be implemented in a communications network in which systems and methods for demand-based content caching may be implemented, in accordance with examples of the disclosure.

FIG. 3 is a schematic diagram of illustrative data and data structures that may be utilized in systems and methods for demand-based content caching, in accordance with examples of the disclosure.

FIGS. 4A and 4B illustrate a flow diagram of an exemplary process for performing determination and configuration of content cache allocation at a content system in which systems and methods for demand-based content caching may be implemented, in accordance with examples of the disclosure.

FIG. 5 is a schematic diagram of illustrative components in an example computing device that may be configured for interacting with a communications network that implements systems and methods for demand-based content caching, in accordance with examples of the disclosure.

FIG. 6 is a schematic diagram of illustrative components in an example computing device that may be configured for performing one or more aspects of demand-based content caching, in accordance with examples of the disclosure.

### DETAILED DESCRIPTION

### Overview

This disclosure is directed in part to systems and techniques for improving the efficiency of resource allocation at various systems and devices involved in content distribution across networks. Such networks may include wireless communications networks, such as any networks that may facilitate wireless communications services for one or more wireless communications devices, as well as any network or combination of networks capable of distributing content of any type. Wireless communications networks may include networks that support one or more 3GPP standards, including, but not limited to, Long Term Evolution (LTE) networks (e.g., 4G LTE networks implementing any variation of 4G LTE technology (may be referred to herein as “4G”)) and New Radio (NR) networks (e.g., 5G NR networks implementing any variation of 5G NR technology (may be referred to herein as “5G”)). However, the disclosed systems and techniques may be applicable in any network, system, or any combination thereof, in which a user device may request and receive content from a content provider for consumption on the user device.

A user device as described herein may be any device capable of rendering or otherwise presenting content of any type to a user. For example, a user device may be any type of wireless communications device (e.g., mobile telephone, smartphone, user equipment (UE), etc.), any type of computing device (e.g., desktop computer, laptop computer, tablet computer, etc.), any type of content presentation device (e.g., television (e.g., smart television), projector (e.g., smart projector) monitor, display, speaker system, etc.), and/or any type of device capable of presenting content of any type to a user. Content as used herein may include video content (e.g., television shows, movies, videos, etc.), audio content (e.g., songs, podcasts, musical content, etc.), application content (e.g., video games, computer applications, etc.), and/or any content that may requested and/or consumed using a user device.

A user device may communicate with one or more networks via a local system or device that may serve as a gateway or network access device. For example, a premises terminal device may be configured at a user's home or office to provide connectivity to a network for one or more devices that may connect to the premises terminal device wirelessly and/or via wired connections. An example of such a premises terminal device may be a cable modem, cable box, router, gateway, etc., that may be configured to facilitate wired and/or wireless communications between user devices and one or more networks (e.g., Internet provider network, wireless communications provider network, etc.). In other examples, a premises terminal device may also be a user device that connects to a network. For example, a premises terminal device may be a smartphone that communicates with one or more base stations (e.g., gNodeB, eNodeB, NodeB, base transceiver station (BTS), etc.) configured at a wireless communications network (e.g., to interact with other devices via the wireless communications network and/or the Internet).

A premises terminal device may have storage resources of various types and sizes. For example, a premises terminal device may be configured with one or more hard drives, mass storage devices, nonvolatile storage components, etc., that may be capable of storing content. Such storage resources that are available to store content and content-associated data may be referred to herein as “cache” or “cache resources.” In examples, when a user requests particular content, a premises terminal device may store such content at its cache for presentation to the user (e.g., for transmission to and/or presentation on a user device).

In traditional content processing systems, a user may generate a request for content on a user device that is communicatively connected to a premises terminal device. The premises terminal device may forward the request to a content provider via a network. The content provider may responsively transmit the content to the premises terminal device that may provide the content to the user device for presentation to the user. For a single content consumption transaction (request and receipt of a particular piece of content), the demands on the resources of the network provider, the content provider, and the premises terminal device are minimal. However, as will be appreciated, with numerous users (e.g., thousands or even millions) requesting content at peak consumption times, the demands on content consumption resources may be significant. For example, during “prime time” (e.g., typically defined as between 8:00 PM and 11:00 PM or 7:00 PM and 10:00 PM local time), the number of users requesting and receiving video content (e.g., television shows, movies, etc.) may be quite large. Servicing these requests may tax network resources, especially because data files associated with video content (e.g., high-definition video content) may be numerous and/or large.

In an effort to alleviate the burden on network resources introduced by servicing large volumes of content requests and transmitting large volumes of content data, content may be cached and content requests may be processed at various systems and devices within the network (e.g., between a user premises and a content provider location). This may reduce the total network pathway required for processing content requests and providing content. This may also reduce the burden on content provider systems by offloading at least some content processing onto systems more proximate to users. However, the content chosen to be cached on such intermediary content processing systems may necessarily be limited to more popular and/or more general interest content as opposed to specific content likely to be requested by particular users. Moreover, the use of such intermediary content processing systems does not reduce the utilization of network resources required to transmit content from an intermediary content processing system to a user premises terminal device.

To address these issues, the disclosed systems and methods facilitate the allocation of cache resources at a premises terminal device based on content demand and the accuracy of content prediction by content providers. In example, a content system may be configured at a premises terminal device and/or at a content processing system (e.g., located at the premises terminal device and/or within the network with which the premises terminal device is communicatively connected). The content system may be configured to receive and process requests for content from user devices and to receive and provide such content to the user devices. The content system may also, or instead, be configured to determine allocations for local storage of content (e.g., at a premises terminal device cache) for one or more content providers and/or account and provider combinations. The content system may update and reconfigure cache allocations based on data associated with content requests collected over time.

For example, the content system may increase cache allocations for particular content providers and/or provider/account combinations that demonstrate high content prediction accuracy and/or that comply with preferred download time windows and/or deadlines, and decrease allocations for particular content providers and/or provider/account combinations that do not. In this way, the disclosed systems and methods make more efficient use of premises terminal device resources and increase the likelihood that requested content is locally available. This in turn improves the user experience by reducing delay due to download times and making content available even when access to the network and/or content provider is limited (e.g., due to content provider and/or network outages). Furthermore, the disclosed systems and methods improve the efficiency of network resource utilization by encouraging content providers to accurately predict content likely to be requested by particular users and to preemptively transmit such content to premises terminal devices when the demands on the network are lower.

In examples, a content system may initially determine an amount of cache available for storing content at a premises terminal device. For example, a content system may determine that a premises terminal device that services a number of user devices (e.g., televisions, smartphones, etc. via wired and/or wireless connections) has a hard drive with an available amount of storage space that may be dedicated to storing content. The content system may then determine one or more cache allocation entities, among which the available amount of content storage space may be divided. A cache allocation entity may be any entity associated with content that may be stored at a premises terminal device. Such entities may include a content provider and a combination of a content provider and a user account.

For instance, a premises terminal device may be configured to provide content (e.g., process content requests and receive content data) from two content providers to various user devices. Moreover, the premises terminal device may be configured to provide content for one user account associated with a first content provider of the two content providers and two user accounts associated with a second content provider of the two content providers. Thus, the premises terminal device may determine three potential cache allocation entities that may compete for cache resources on the premises terminal device: (1) the first content provider (or the combination of the one user account associated with the first content provider); (2) the combination of a first user account associated with the second content provider; and (3) the combination of the second user account associated with a second content provider.

The content system may then determine an initial cache allocation for the various cache allocation entities. In examples, the content system may use a default allocation for the initial allocation of cache resources (e.g., before any cache allocation performance data has been determined), such as evenly splitting the cache between the various cache allocation entities. Alternatively, the content system may use one or more initial allocation factors to determine the initial allocation of cache resources, such as stored preference and/or popularity data that may be associated with various cache allocation entities (e.g., preference data indicating a preference, and therefore larger cache allocation, for a particular content provider, popularity data indicating that a particular content provider is more popular and therefore should be allocated a larger cache allocation, etc.).

The content system may generate one or more “offers” of cache resources that may be provided to one or more content providers. For example, the content system may transmit a request for predicted content to a particular content provider. Such a request may include an amount of cache resource available to the content provider and an indication of a user account. The request may further include temporal parameters. For example, the request may indicate one or more windows of time during which the content provider is requested to transmit content to the premises terminal device for storage at the premises terminal device cache (may be referred to as a “content download window”). The request may also, or instead, indicate one or more deadlines by which content is requested to have been stored at the cache of the premises terminal device (may be referred to as a “content download deadline”). Other parameters may also, or instead, be included in such a request. This request may be provided to a content provider via an application programming interface (API) configured for such communications and/or using any other suitable means of communication.

The content provider may affirmatively (or negatively) respond to such a request, which may in turn cause the content system to store data indicating the response and/or any other associated data. In examples, the content provider and the content system may exchange messages to negotiate the cache allocation terms. For instance, the content provider may request different parameters (e.g., more or less cache space, different content download window(s), different content download deadline(s), etc.). The content system may be configured to respond to such proposals and/or perform automated negotiation operations. Alternatively, the content system may allocate cache resources as initially determined regardless of any responses received from content providers. In other examples, the content system may not notify content providers of initially determined (or updated) cache allocation parameters and may monitor utilization of cache resources based on such allocations, reallocating periodically as described herein without interacting with one or more content providers. The cache allocation entity may initiate a request to discover its current allocation of cache resources via an application programming interface (API) configured for such communications and/or using any other suitable means of communication.

The content system may then monitor and track the usage of the cache as initially allocated and compliance with the initially determined cache allocation parameters. For example, the content system may track the number of content requests that it processes. The content system may further track whether the content requested for each content request has been proactively provided to the premises terminal device cache by the content provider. If a particular requested piece of content is already stored on the premises terminal device cache when it is requested by a user, that content access may count as a “hit” or successful cache access for the cache allocation entity (e.g., content provider or provider/account combination) associated with that particular requested piece of content. The content system may store data indicating such hits for each cache allocation entity. The content system may also, or instead, store data indicating “misses” for each such cache allocation entity when requested content associated with a cache allocation entity is not already stored at the premises terminal device cache.

The content system may generate data in a variety of forms indicating the cache access success rate for the various cache allocation entities. For example, for a period of time, the content system may track a total number of content requests directed towards a single cache allocation entity. The content system may then track a number of hits for each cache allocation entity during that period of time. The content system may then determine the cache access rate (“hit rate”) for that period of time for each cache allocation entity as the ratio of hits to a total number of content requests. For instance, a first cache allocation entity may have been able to service five of 32 content requests using cached data, while a second cache allocation entity may have been able to service nine of the 32 content requests using cached data. In this example, the first cache allocation entity may have a hit rate of 5/32 (may be approximated to 16%) and the second cache allocation entity may have a hit rate of 9/32 (may be approximated to 32%). Any other methods or means of determining a hit rate may be used instead of, or in addition to, a proportional measurement of premises terminal device cache access to content requests.

The content system may also, or instead, generate data in a variety of forms indicating the usage rate of preferred download windows for the various cache allocation entities. For example, for a period of time, the content system may track the times at which content is downloaded to the premises terminal device cache for each cache allocation entity. The content system may then determine how often such downloads take place during a preferred or requested download window associated with the corresponding cache allocation entity. The content system may determine a download window usage rate for that period of time for each cache allocation entity as the ratio of the download times that occurred during the preferred download window period to the total download time for the cached content associated with that cache allocation entity. For instance, a first cache allocation entity may have taken 12 hours total to download its associated content to a premises terminal device cache during the time period, and eight of those hours may have been during the preferred download window period for that first cache allocation entity. A second cache allocation entity may have taken 15 hours to download its associated content to the premises terminal device cache, with five of those hours falling during the preferred download window period for that second cache allocation entity. In this example, the first cache allocation entity may have a download window usage rate of 8/12 (i.e., 2/3^{rds}; may be approximated to 67%) and the second cache allocation entity may have a download window usage rate of 5/15(i.e., 1/3^{rd}; may be approximated to 33%). Any other methods or means of determining a download window usage rate may be used instead of, or in addition to, a proportional measurement of time used for downloads during a preferred download window period to a total time used for downloads.

Note that in various examples, a preferred download window period may vary for different cache allocation entities. For example, a first cache allocation entity may have a shorter preferred download window period (e.g., 12:00 AM-3:00 AM), while a second may have a longer and staggered, relative to the preferred download window period for the cache allocation entity, preferred download window period (e.g., 4:00 AM-8:00 AM). A preferred download window period may also vary depending on location and/or other criteria that may be associated with a premises terminal device and/or its location in the network. For example, certain regions or locations may have different peak utilization times, and therefore download windows determined for such areas may differ from windows determined for different regions or locations. Within a region or location, the preferred download window may not be static, and may change over time. A preferred download window period may be determined for a particular cache allocation entity using any criteria and/or parameters.

The content system may also, or instead, generate data in a variety of forms indicating the success rate of downloading content by a requested or preferred deadline for the various cache allocation entities. For example, for a period of time, the content system may track the times at which content downloads to the premises terminal device cache are completed by each cache allocation entity. The content system may then determine how often such downloads are completed by a preferred or requested download deadline associated with the corresponding cache allocation entity. The content system may then determine a download deadline rate for that period of time for each cache allocation entity as the ratio of the number of downloads completed by the requested download deadline to the total number of content downloads associated with that cache allocation entity. For instance, a first cache allocation entity may have downloaded 15 pieces of its associated content to a premises terminal device cache, and nine of those pieces of content may have been fully downloaded by the preferred download deadline for that first cache allocation entity. A second cache allocation entity may have downloaded 21 pieces of its associated content to a premises terminal device cache, and 19 of those pieces of content may have been fully downloaded by the preferred download deadline for that second cache allocation entity. In this example, the first cache allocation entity may have a download deadline success rate of 9/15 (i.e., 3/5; may be represented as 60%) and the second cache allocation entity may have a download deadline success rate of 19/21 (i.e., may be approximated to 90%). Any other methods or means of determining a download deadline success rate may be used instead of, or in addition to, a proportional measurement of successful downloads by a deadline to a total number of downloads.

Note that in various examples, a preferred download deadline may vary for different cache allocation entities. For example, a first cache allocation entity may have a deadline based on typical consumption of content associated with that cache allocation entity (e.g., 7:00 PM), while a second cache allocation entity may have an earlier (or later) deadline based on typical consumption of content associated with that cache allocation entity (e.g., 2:00 PM, 9:00 PM) occurring at a different time. A preferred download deadline may be determined for a particular cache allocation entity using any criteria and/or parameters.

The period of time over during which the content system monitors cache allocation performance in order to determine allocation adjustments may be preconfigured and/or dynamically determined. For example, the content system may be configured to determine updated cache allocation parameters every day, week, month, a particular number of hours, etc. The content system may use only the data associated with the current cache allocation monitoring period of time to determine cache allocation adjustments. Alternatively, the content system may use data aggregated over several periods of time (e.g., a number of most recent cache allocation monitoring periods) to determine allocation adjustments.

Based on the cache allocation performance data, the content system may determine a cache allocation factor for each cache allocation entity associated with a premises terminal device. For example, where the cache allocation performance data (e.g., hit rate, download window usage rate, download deadline success rate) takes the form of ratios or percentages, the content system may average such data for each cache allocation entity to determine a cache allocation factor. Alternatively, the content system may use any other means or methods, including algorithms of any type, to determine a cache allocation factor for a particular cache allocation entity.

Based on the cache allocation factor for each cache allocation entity, the content system may determine updated cache allocation data for the various cache allocation entities. For example, the content system may increase or decrease the amount of cache resources dedicated to a particular cache allocation entity based on its associated cache allocation factor.

In examples, cache allocation factors may be algorithmically compared to determine the updated cache allocation data. For example, a relative value for each cache allocation factor may be determined for a particular cache allocation entity to determine an updated amount of cache to configure for the entity. For instance, a first entity of two cache allocation entities serviced by a premises terminal device may have a cache allocation factor of 0.65 (e.g., based on an average of the hit rate, download window usage rate, download deadline success rate for that entity). The second of the two entities may have a cache allocation factor of 0.45 (e.g., based on an average of the hit rate, download window usage rate, download deadline success rate for that entity). The content system may then update the cache allocated to each entity based on the relative value of their allocation factors. For example, the content system may determine that the first entity is to be allocated 59% of available content cache based on its factor relative to the total value of the allocation factors (e.g., 0.65/(0.65+0.45) approximated to 0.59 or 59%) and that the second entity is to be allocated 41% of available content cache based on its factor relative to the total value of the allocation factors (e.g., 0.45/(0.65+0.45) approximated to 0.41 or 41%). Alternatively, the content system may use any other means or methods, including algorithms of any type, to determine a cache allocation factor for a particular cache allocation entity.

The content system may also update other cache allocation parameters based on a determination made using, at least in part, the cache allocation performance data and/or resource utilization data (historical and/or predicted). For example, the content system may update one or both of a download window and download deadline for each particular cache allocation entity based on one or more criteria. For instance, one or both of a download window and a download deadline may be determined such that the window and/or deadline is outside of one or more historically high network utilization time periods and/or one or more time periods during which high network utilization is predicted (e.g., during a major sporting event, etc.). The download windows and/or download deadlines may vary based on content schedules. For example, during most weekdays, a download window may fall between 10:00 PM and 2:00 AM, whereas on a day where major sporting event occurs during this time, the download window may be shifted to between 12:00 AM and 4:00 AM.

The content system may generate one or more updated “offers” of cache resources that may be provided to one or more content providers based on the updated cache allocation data. For example, the content system may transmit another request for predicted content to a particular content provider including the updated amount of cache resource available to the content provider (and, in some examples, updated download window and/or updated download deadline) and an indication of a user account. Here again, this request may be provided to a content provider via an API configured for such communications and/or using any other suitable means of communication.

As with the initial request, the content provider may affirmatively (or negatively) respond to such a request, which may in turn cause the content system to store data indicating the response and/or any other associated data. In examples, the content provider and the content system may exchange messages to negotiate the updated cache allocation terms. For instance, the content provider may request different parameters (e.g., more or less cache space, different content download window(s), different content download deadline(s), etc.). Alternatively, the content system may allocate updated cache resources regardless of any responses received from content providers. In other examples, the content system may not notify content providers of updated determined (or updated) cache allocation parameters and may monitor utilization of cache resources based on such allocations, reallocating periodically as described herein without interacting with one or more content providers.

By facilitating the use of cache allocation performance data to determine cache resource allocations for cache allocation entities, the systems and methods described herein provide more efficient use of cache and network resources and an improved user experience. By incentivizing the use of network resources at lower demand time periods for content downloads and more accurate predictions of requested content, network traffic during peak times (e.g., “prime time”) is reduced and resources are preserved for demanding real-time operations that are not able to benefit from caching (e.g., video calling/conferences, multi-player gaming, etc.). For example, the methods and systems described herein may be more efficient and/or more robust than conventional techniques, as they may reduce the use of resources by preemptively downloading predicted content to a user premises, reducing the use of network resources during peak times for downloading such content and improving responsiveness for the user as the content is preemptively and locally stored. That is, the methods and systems described herein provide a technological improvement over existing content management systems and methods by more efficiently making use of terminal device cache resources by increasing cache allocation for providers making better use of the cache resources, while incentivizing reductions in usage of the network at peak times. In addition to improving the efficiency of network and device resource utilization, the systems and methods described herein can provide more robust systems by, for example, making content available locally to a user even when network and/or content provider access is limited or unavailable, thereby freeing network and device resources for more productive operations during such times.

Illustrative environments, signal flows, and techniques for implementing systems and methods for demand-based content caching are described below. However, the described systems and techniques may be implemented in other environments.

### Illustrative System Architecture

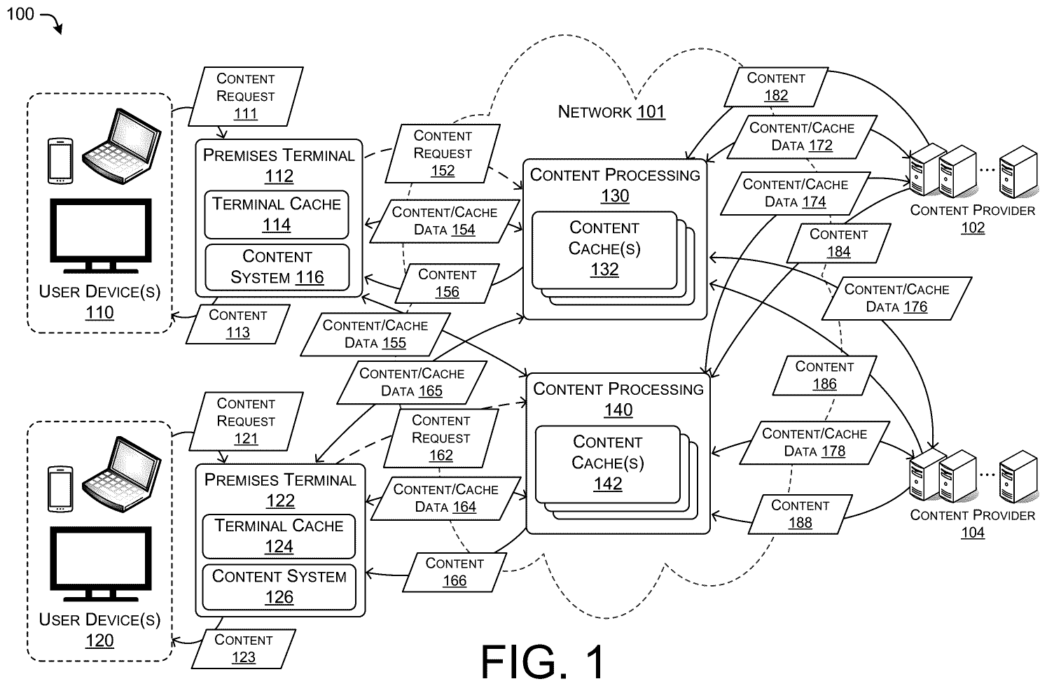

FIG. 1 is a schematic diagram of an illustrative network environment 100 in which the disclosed systems and techniques may be implemented. A network 101, which may be a communications network (e.g., wireless and/or wired) of any type or any combination of networks of any type, may be configured in the environment 100. In examples, the network 101 may be a network that supports 4G and/or 5G technologies and may include components that are configured to support 4G and/or 5G technologies and facilitate associated communications. The network 101 may be a network may be a network that supports communication between user devices and content provider systems, including communication via the Internet.

The environment 100 may include one or more user devices 110 that may be operated by one or more users at a user's premises (e.g., home, office, etc.). For example, the user device(s) 110 may include one or more smartphones, televisions, and/or computers of any type. The user device(s) 110 may communicate (wirelessly and/or via wired connection(s)) with a premises terminal 112. The premises terminal 112 may be any one or more premises terminal devices that may be configured to provide connectivity to the network 101 for one or more of the user device(s) 110. For example, the premises terminal 112 may be a network terminal or other form of customer premise equipment (CPE). Alternatively, the premises terminal 112 may be integrated into or a component of one or more of the user device(s) 110 and may facilitate communication with the network 101 using wireless communications means (e.g., 4G or 5G communications with the network 101 via a base station).

The premises terminal 112 may be configured with and/or to access terminal cache 114 that may be storage device or component of any type that may be used to store content of any type. The premises terminal 112 may further be configured with and/or to interact with a content system 116. The content system 116 may be configured to determine cache allocation parameters and cache allocation performance data as described herein. The content system 116 may further be configured to interact with one or more provider systems and/or devices as described herein.

The environment 100 may also include one or more user devices 120 that may be operated by one or more users at another user's premises (e.g., home, office, etc.). As with user device(s) 110, the user device(s) 120 may include one or more smartphones, televisions, and/or computers of any type. The user device(s) 120 may communicate (wirelessly and/or via wired connection(s)) with a premises terminal 122. The premises terminal 122 may be any one or more premises terminal devices that may be configured to provide connectivity to the network 101 for one or more of the user device(s) 120. For example, the premises terminal 122 may be a network terminal or other form of CPE. Alternatively, the premises terminal 122 may be integrated into or a component of one or more of the user device(s) 120 and may facilitate communication with the network 101 using wireless communications means (e.g., 4G or 5G communications with the network 101 via a base station).

The premises terminal 122 may be configured with, and/or configured to access, a terminal cache 124 that may be storage device or component of any type that may be used to store content of any type. The premises terminal 122 may further be configured with and/or to interact with a content system 126. The content system 126 may be configured to determine cache allocation parameters and cache allocation performance data as described herein. The content system 126 may further be configured to interact with one or more provider systems and/or devices as described herein.

The environment 100 may also include one or more content providers, such as content provider 102 and content provider 104. The content providers 102 and 104 may be providers of any type of content, including streaming video and/or audio content, video games, computer applications, etc. In examples, there may be one or more devices within the network 101 that cache and otherwise facilitate the provision of content on behalf of the content providers 102 and/or 104. For example, a content processing component 130 may be configured in the network 101. The content processing component 130 may be configured with one or more content caches 132 that may be configured to store content provided by one or more of the content providers 102 and/or 104. Similarly, a content processing component 140 may be configured with one or more content caches 142 in the network 101 and further configured to store content provided by one or more of the content providers 102 and/or 104. In examples, the content processing components 130 and 140 may be located in geographically distinct regions to provide content on behalf of the content providers 102 and/or 104 to users in those regions. Alternatively or additionally, the content processing components 130 and 140 may serve as redundant sources of content for users of the content providers 102 and/or 104.

The content processing components 130 and 140 may be owned and/or operated by the content providers 102 and/or 104. For example, the content processing component 130 may be owned and/or operated by the content provider 102, while the content processing component 140 may be owned and/or operated by the content provider 104. Alternatively, the content processing components 130 and 140 may be owned and/or operated by the operator of the network 101 to provide content on behalf of the content providers 102 and/or 104.

The premises terminals 112 and/or 122 may communicate with content providers 102 and/or 104 and/or the content processing components 130 and/or 140 via the network 101. For example, premises terminals 112 and/or 122 may transmit requests for content received from user devices to the appropriate content provider and/or content processing component in order to download the requested content.

For instance, the premises terminal 112 may receive a content request 111 from the user device(s) 110. In response, the premises terminal 112 may determine whether the content indicated in the content request 111 is currently stored on the terminal cache 114. If so, the premises terminal 112 may transmit the requested content as content 113 to the requesting user device(s) 110. If the requested content is not currently stored on the terminal cache 114, the premises terminal 112 may generate and transmit a content request 152 (e.g., forward content request 111) to the appropriate content provider and/or content processing component (e.g., to content processing component 130 in this example, which may request the content from the content provider 102 if it is not already stored at content cache(s) 132) in order to download the requested content. Premises terminal 122 may perform similar operations in response to a content request 121 from user device(s) 120, generating content request 162 as needed and transmitting content 123 to the requesting user device(s) 120.

In examples, one or both of the content systems 116 and 126, configured at premises terminals 112 and 122, respectively, may perform one or more cache allocation operations as described herein. For example, the content system 116 may determine cache resources of the terminal cache 114 that may be available for storing content (e.g., storage device space, hard drive space, etc. that may be dedicated to storing content). The content system 116 may then determine an initial cache allocation and/or other cache allocation parameters for the various cache allocation entities with which the premises terminal 112 may interact. As noted above, a cache allocation entity may be a content provider, such as content provider 102 or content provider 104, and/or a combination of a user account and such a content provider. The content system 126 may perform similar operations based on the terminal cache 124 and for the various cache allocation entities with which the premises terminal 122 may interact.

The content systems 116 and/or 126 may transmit an “offer” or other cache allocation request to one or more of the cache allocation entities with which the premises terminals 112 and/or 122, respectively, may interact. The content systems 116 and/or 126 may also receive responses and/or other messages associated with such requests and/or perform negotiation operations with such cache allocation entities. In FIG. 1, these exchange(s) of cache allocation data are represented as “content/cache data.”

For example, the premises terminal 112 may exchange content/cache data 154 with the content processing component 130. The content processing component 130 may be configured to perform cache allocation operations as described herein (e.g., providing content based on the cache allocation request or offer) on behalf of one or both of the content providers 102 and 104. Alternatively or additionally, the content processing component 130 may be configured to forward such requests as content/cache data 172 and/or content cache data 176 to the appropriate content provider and/or facilitate the exchange of content/cache data between the premises terminal 112 and one or more of the content provider 102 and the content provider 104. The premises terminal 112 may perform similar interactions via content/cache data 155 with the content processing component 140. Alternatively or additionally, the premises terminal 112 may exchange content/cache data with the one or more of the content providers 102 and 104 without traversing or otherwise involving the content processing component 130.

Similarly, the premises terminal 122 may exchange content/cache data 164 with the content processing component 140. The content processing component 140 may be configured to perform cache allocation operations as described herein (e.g., providing content based on the cache allocation request or offer) on behalf of one or both of the content providers 102 and 104. Alternatively or additionally, the content processing component 140 may be configured to forward such requests as content/cache data 174 and/or content cache data 178 to the appropriate content provider and/or facilitate the exchange of content/cache data between the premises terminal 122 and one or more of the content provider 102 and the content provider 104. The premises terminal 122 may perform similar interactions via content/cache data 165 with the content processing component 130. Alternatively or additionally, the premises terminal 122 may exchange content/cache data with the one or more of the content providers 102 and 104 without traversing or otherwise involving the content processing component 140.

Based on this content/cache data, the content processing components 130 and/or 140 may transmit content to one or more of the premises terminals 112 and 122 for storage at their respective caches. For example, the content processing component 130 may transmit content 156, which may be any type and quantity of content transmitted at any one or more times, to the premises terminal 112. The content processing component 140 may transmit content 166, which may be any type and quantity of content transmitted at any one or more times, to the premises terminal 122. The content processing component 130 may also transmit content (not shown) to the premises terminal 122 and the content processing component 140 may also transmit content (not shown) to the premises terminal 112. Such content may be initially retrieved from the content providers (e.g., as content 182, 184, 186, and/or 188). Alternatively or additionally, the content may be transmitted, based on content/cache data, from one or more of the content providers 102 and 104 to the premises terminals 112 and 122, with or without involving one or more of the content processing components 130 and 140.

As described in more detail herein, the content systems 116 and/or 126 may monitor cache usage at their respective premises terminals to determine cache allocation performance data. Based on this cache allocation data, the content systems may update the cache allocation parameters for their respective terminals and caches. These updates may be communicated via content/cache data communications exchanges (e.g., 154, 155, 164, 165) and content provided (e.g., 156, 166, 182, 184, 186, 188) to the premises terminal(s) based on such updates.

### Illustrative Components and Communications

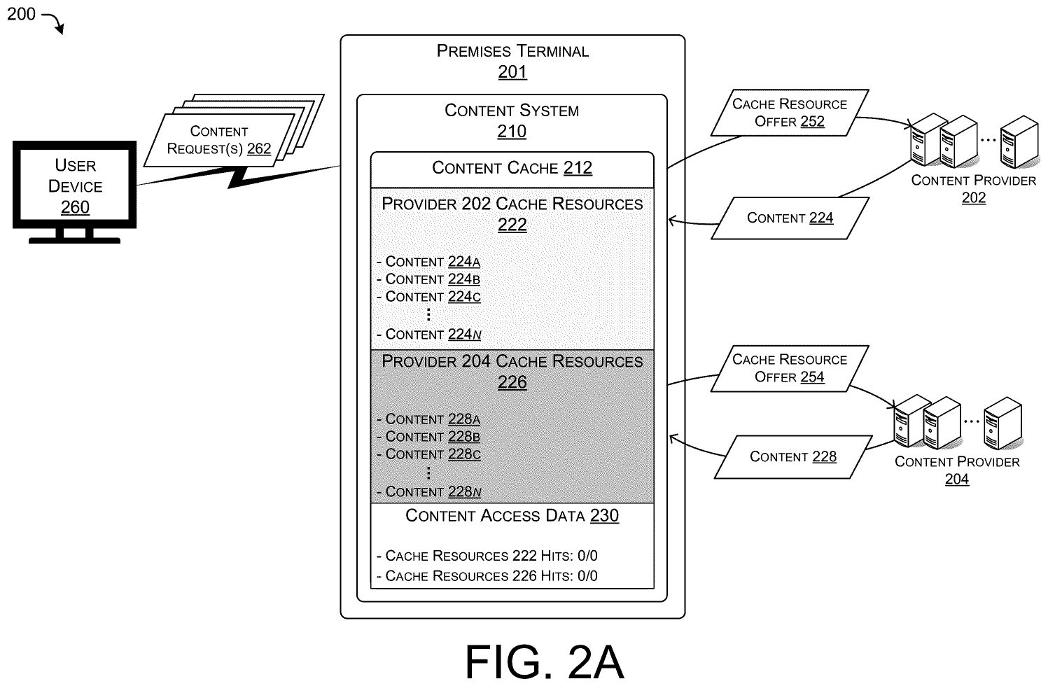

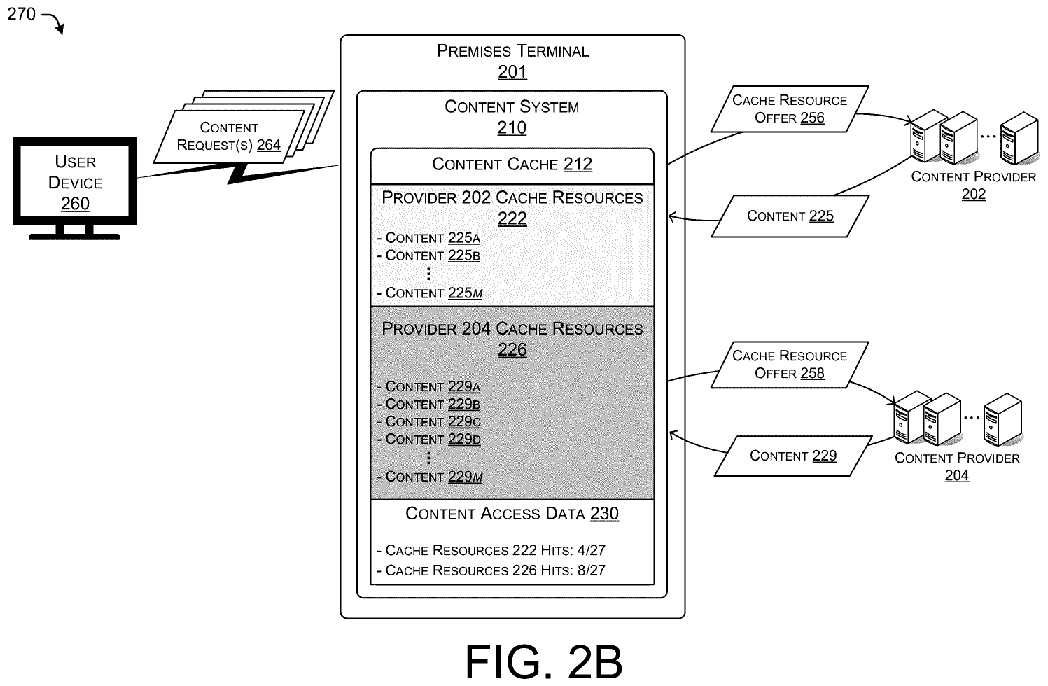

FIGS. 2A and 2B illustrate schematic diagrams of exemplary components, communications, and data structures that may be included and/or implemented in one or more of the disclosed systems and techniques for determining and configuring cache allocation parameters and demand-based content caching. Reference may be made in this description of the exemplary functions and communications to devices, messages, functions, components, and/or operations illustrated in other figures and described in regard to such figures. However, the components, communications, and data structures illustrated in FIGS. 2A and 2B and described herein may be implemented in any suitable system and/or with any one or more suitable devices and/or entities. Moreover, any of the operations and communications described in regard to FIGS. 2A and 2B may be used separately and/or in conjunction with other operations and communications and/or implemented using any components, devices, systems, and/or operations. All such embodiments are contemplated as within the scope of the instant disclosure.

FIG. 2A illustrates schematic diagram 200 that may represent a subset of the functions and components similar to those represented in environment 100 of FIG. 1. In this example, a user device 260 may be in communication with a premises terminal 201. The user device 260 may be any type of user device capable of rendering or otherwise providing content of any type to a user, including, but not limited to, any type of user device described herein. The premises terminal 201 may be any type of premises terminal device capable of facilitating communications between a network and a user device, including, but not limited to, any type of premises terminal device described herein. In examples, the user device 260 may be a distinct device from the premises terminal 201 and may communicate with the premises terminal 201 using any form of electronic communications, including wireless and/or wired communications. Alternatively, the premises terminal 201 may be a component of, and configured at, the user device 260. In examples, the premises terminal may be configured to interact with one or both of a content provider 202 and a content provider 204 to obtain content for transmission to the user device 260.

The premises terminal may include a content system 210 that may be configured to perform one or more of the cache allocation and demand-based content caching operations described herein. The content system 210 may be configured to control and/or monitor the content cache 212 that may represent the cache resources configured at or otherwise available to the premises terminal 201 for content caching and related data. The content system 210 may determine an initial allocation of the content cache 212 for the cache allocation entities with which the premises terminal 201 may interact. In this example, content providers 202 and 204 may be such cache allocation entities.

The content system 210 may determine that cache resources 222 may be allocated to the provider 202 and that the cache resources 226 may be allocated to the provider 204. The content system 210 may determine substantially equal allocations of cache resources 222 and 226 as initial allocations of the content cache 212 to the cache allocation entities.

The content system 210 may transmit cache resource offers 252 and 254 to the providers 202 and 204, respectively, based on the initial allocations of the content cache 212. The providers 202 and/or 204 may respond and/or negotiate with the content system 210. The providers may also, or instead, transmit content as content 224 (associated with content provider 202) and content 228 (associated with content provider 204). The content system 210 may store the received content in the cache resource associated with the provider from which such content was received (e.g., store content 224a . . . n in cache resources 222; store content 228a . . . n in cache resources 226). The content system 210 may store data associated with the reception and/or download of such content as described herein, such as whether the content was received within a preferred download window and/or whether the content was received before a requested download deadline.

The premises terminal 201 may receive one or more content requests 262 from the user device 260. The content system 210 may determine whether such requests were satisfied using content stored in the content cache 212 and, if so, which cache allocation entity resources were used to satisfy the request (e.g., whether there is a “hit” at a particular cache allocation). In the example of FIG. 2A, such data may be stored as content access data 230. This example illustrates an initial condition of the content cache 212 and therefore no hits are stored.

FIG. 2B illustrates a schematic diagram 270 that may represent updated components and data of FIG. 2B. After some time period and/or other criteria have been met, the content system 210 may determine the “hit rate” for each of the cache resource allocations (and therefore for each of the cache allocation entities (e.g., providers 202 and 204)). As shown here in updated content access data 230, the cache resources 222 may have a lower hit rate than the cache resources 226 (in this example, a hit rate of 4/27 for cache resources 222 vs. a hit rate of 8/27 for cache resources 226). This disparity in cache allocation performance may indicate that the cache allocation entity associated with the cache resources 226 (provider 204) is better at predicting content to be requested by users than the cache allocation entity associated with the cache resources 222 (provider 202). In response to this disparity in cache allocation performance, the content system 210 may update the allocations and allocation parameters for the cache allocation entities.

For example, because the cache resources 222 are associated with a lower relative hit rate, the content system 210 may reduce the amount of cache resources dedicated to the cache resources 222 (and thus to the associated cache allocation entity, provider 202). Likewise, because the cache resources 226 are associated with a higher relative hit rate, the content system 210 may increase the amount of cache resources dedicated to the cache resources 226 (and thus to the associated cache allocation entity, provider 204). The content system 210 may then provide updated cache resource offers 256 and 258 to providers 202 and 204, respectively, based on these updated cache resource allocations.

The providers 202 and/or 204 may (e.g., again) respond and/or negotiate with the content system 210. The providers may also, or instead, transmit content as content 225 (associated with content provider 202) and content 229 (associated with content provider 204). The content system 210 may store the received content in the updated cache resource associated with the provider from which such content was received (e.g., store content 225a . . . m in cache resources 222; store content 229a . . . m in cache resources 226). The content system 210 may store data associated with the reception and/or download of such content as described herein, such as whether the content was received within a preferred download window and/or whether the content was received before a requested download deadline.

The premises terminal 201 may receive one or more further content requests 264 from the user device 260. The content system 210 may determine whether such requests were satisfied using content stored in the content cache 212 and, if so, which cache allocation entity resources were used to satisfy the request (e.g., whether there is a “hit” at a particular cache allocation). Such data may be stored as content access data 230. After a time period and/or other criteria have been met, the content system 210 may again determine cache allocation performance data and update cache allocations for the various cache allocation entities.

### Illustrative Data and Data Structures

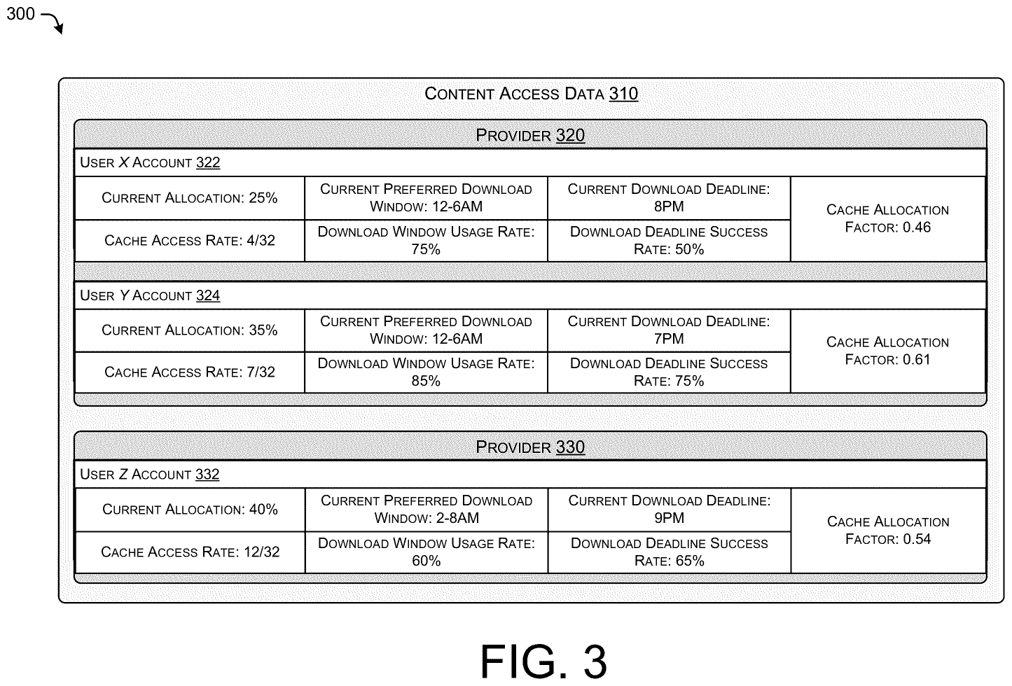

FIG. 3 shows a diagram of an illustrative data structure 300 for representing cache allocation parameters and performance data according to the disclosed embodiments. The data structure 300 contains exemplary data that may be generated, stored, and/or processed according to the disclosed examples; however, other data and stat structures may also, or instead, be used in conjunction with the disclosed examples.

The data structure 300 may include content access data 310 representing cache allocation parameters and performance data for one or more cache allocation entities. For example, a content system may interact with a provider 320 on behalf of two user accounts, user X account 322 and user Y account 324. Thus, the combination of provider 320 and user X account 322 may represent a single cache allocation entity, while the combination of provider 320 and user Y account 324 may represent another, distinct, cache allocation entity. The content system may interact with a provider 330 on behalf of a single user account, user Z account 332. In such examples, the provider 330 may represent a single cache conception entity, or the combination of provider 330 and user Z account 332 may represent a single cache allocation entity, regardless of the number of other accounts associated with the provider 330.

As described herein, various cache allocation parameters may be determined for and/or associated with a cache allocation entity. For example, each cache allocation entity may have an associated current cache resource allocation (e.g., as shown in the figure, 25% of available cache resources for provider 320/account 322; 35% of available cache resources for provider 320/account 324; 40% of available cache resources for provider 330/account 332). Each cache allocation entity may also, or instead, have an associated current preferred download window (e.g., as shown in the figure, 12-6 AM for provider 320/account 322; 12-6 AM for provider 320/account 324; 2-8 AM for provider 330/account 332). Each cache allocation entity may also, or instead, have an associated current download deadline (e.g., as shown in the figure, 8 PM for provider 320/account 322; 7 PM for provider 320/account 324; 9 PM for provider 330/account 332).

The content system may track cache allocation performance for one or more of the cache allocation parameters associated with various cache allocation entities. For example, the content system may track a total number of content requests received from user devices (e.g., for a time period) and also track whether such requests were satisfied using content already stored at a cache resource allocation for a cache allocation entity. For instance, each cache allocation entity may have an associated cache access rate (hit rate) (e.g., as shown in the figure, 4 of 32 requests for content were satisfied using cache resources dedicated to provider 320/account 322; 7 of 32 requests for content were satisfied using cache resources dedicated to provider 320/account 324; 12 of 32 requests for content were satisfied using cache resources dedicated to provider 330/account 332).

Other cache allocation performance data determined may include a download window usage rate that may indicate, for a period of time, how often content downloads for a cache conception entity take place during a preferred or requested download window associated with that cache allocation entity. For instance, each cache allocation entity may have an associated download window usage rate (e.g., as shown in the figure, 75% for provider 320/account 322; 85% for provider 320/account 324; 60% for provider 330/account 332).

Still other cache allocation performance data determined may include a download deadline success value that may indicate, for a period of time, how often downloads of content for a particular cache allocation entity are completed by a preferred or requested download deadline associated with that cache allocation entity. For instance, each cache allocation entity may have an associated download deadline success value (e.g., as shown in the figure, 50% for provider 320/account 322; 75% for provider 320/account 324; 65% for provider 330/account 332).

Based on the various cache allocation performance data available for a cache allocation entity, the content system may determine a cache allocation factor for that entity that the content system may then use to update cache allocation parameters for the entity. For instance, each cache allocation entity may have an associated cache allocation factor (e.g., as shown in the figure, 0.46 for provider 320/account 322; 0.61 for provider 320/account 324; 0.54 for provider 330/account 332). This factor may be determined using any algorithm or other means, including weighting particular values of cache allocation performance data based on various criteria. For example, a cache allocation factor may be a simple average of the values of cache allocation performance data for a particular cache allocation entity. Alternatively, the values for cache access rate (hit rate) may be weighted more heavily in determining a cache allocation factor. Other cache allocation performance data values may be weighted or otherwise manipulated to emphasize particular performance characteristics that may be more desirable.

### Illustrative Operations

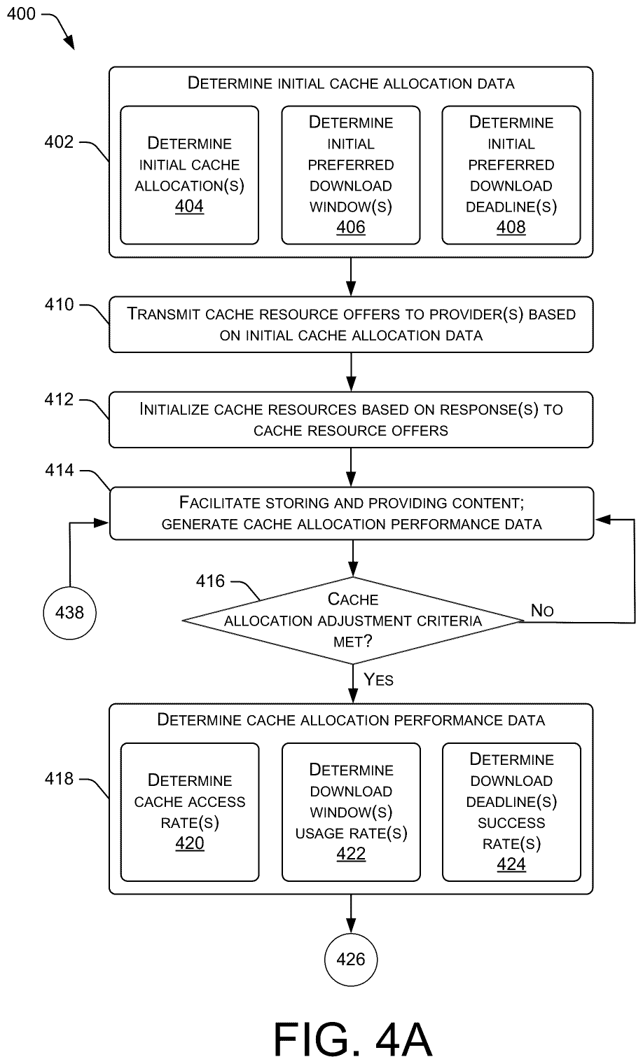

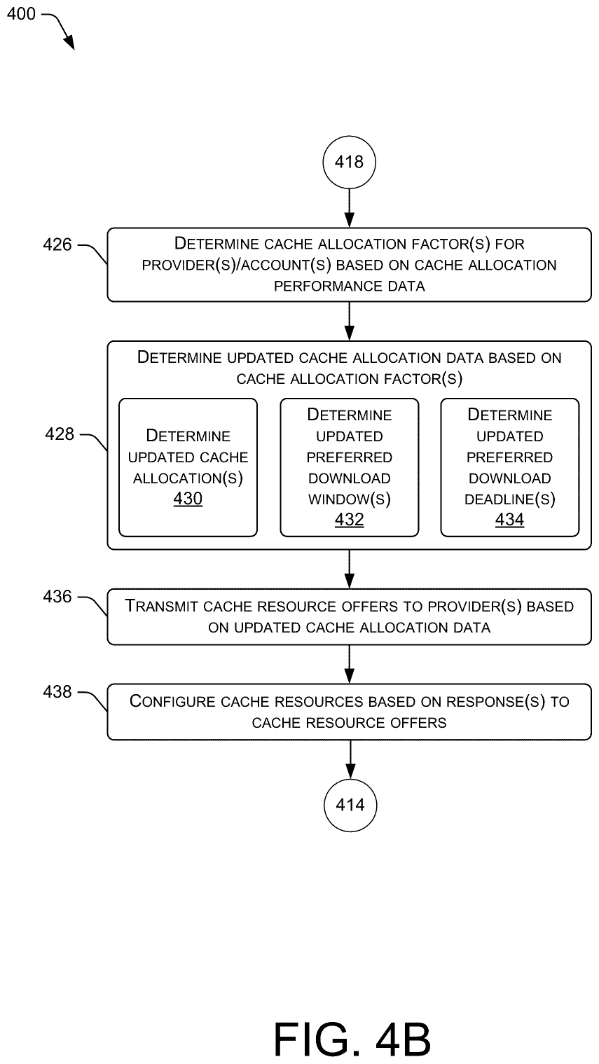

FIGS. 4A and 4B show flow diagrams for an illustrative process 400 for determining and configuring cache allocation parameters and demand-based content caching according to the disclosed embodiments. The process 400 is illustrated as a collection of blocks in a logical flow diagram, which represents a sequence of operations that can be implemented in software and executed in hardware. In the context of software, the blocks represent computer-executable instructions that, when executed by one or more processors, perform the recited operations. Generally, computer-executable instructions include routines, programs, objects, components, data structures, and the like that perform functions and/or implement particular abstract data types. The order in which the operations are described is not intended to be construed as a limitation, and any number of the described blocks can be omitted and/or combined in any order and/or in parallel to implement the processes. For discussion purposes, the process 400 may be described with reference to the network environment 100 of FIG. 1; the example components, communications, and data of FIGS. 2A and 2B; and the example data and data structures of FIG. 3; however, other environments, components, data, and data structures may also be used.

At operation 402, a content system may determine initial cache allocation data for cache resources that may be available at a premises terminal device for storing content. For example, at operation 404, a content system may determine an initial cache allocation for one or more cache allocation entities with which the premises terminal device may interact. In examples, the content system may use a default allocation for this initial allocation of cache resources (e.g., prior to determinations of cache allocation performance data). The default cache allocation may be an even distribution of available cache resources, allocating a same or similar amount of storage space to each of one or more cache allocation entities. Alternatively, at operation 404 the content system may use one or more initial allocation factors to determine the initial allocation of cache resources, such as one or more stored preferences and/or popularity data that may be associated with various cache allocation entities.

Also as part of operation 402, at operation 406, the content system may determine an initial preferred download window for one or more cache allocation entities with which the premises terminal device may interact. The content system may initially determine a same or similar download window for each of one or more cache allocation entities. Alternatively, the content system may initially determine distinct windows for the entities. For example, to encourage use of the network at different times, the content system may determine an earlier window for one cache conception entity (e.g., 12:00 AM-3:00 AM) and a later window for another cache conception entity (e.g., 4:00 AM-7:00 AM). In another example, the content system may determine a larger window for one cache conception entity that may be associated with larger bandwidth downloads (e.g., 12:00 AM-6:00 AM) and a smaller window for another cache conception entity that may be associated with smaller bandwidth downloads (e.g., 2:00 AM-4:00 AM). Any other criteria and/or factors may be used to determine an individual download window for individual cache allocation entities.

Further as part of operation 402, at operation 408, the content system may determine an initial preferred download deadline for one or more cache allocation entities with which the premises terminal device may interact. The content system may initially determine a same or similar download deadline for each of one or more cache allocation entities. Alternatively, the content system may initially determine distinct deadlines for the entities. For example, based on associated user content consumption, the content system may determine an earlier deadline for one cache conception entity associated with a user who tends to consume content earlier in the day (e.g., 7:00 PM) and a later deadline for another cache conception entity associated with a (e.g., distinct) user who tends to consume content later in the day (e.g., 9:00 PM). Any other criteria and/or factors may be used to determine an individual download deadline for individual cache allocation entities.

Using the cache allocation data determined at operation 402, at 410, the content system may transmit (e.g., via an API configured for such communications and/or using any other suitable means of communication) one or more cache resources “offers” or requests to one or more cache allocation entities. In examples, such an offer may take the form of a request for predicted content transmitted to a particular cache allocation entity. Such a request may not indicate the predicted content, but rather requests that the cache allocation entity determine the predicted content, informing the cache allocation entity of the space available at the premises terminal device for storage of such content, as well, in some examples, a download windows and/or download deadline determined for that cache allocation entity.

In examples, the content system may await confirmation from a cache allocation entity before allocating cache resources to the entity. Alternatively, the content system may proceed with such allocations regardless of response, or at least in the absence of a negative response, from the cache allocation entity. In still other examples, the cache allocation entity may exchange negotiation messages to determine the cache allocation parameters to be implemented at the premises terminal device. In other examples, the content system may not notify cache allocation entities of initially determined (or updated) cache allocation parameters and may monitor utilization of cache resources based on such allocations, reallocating periodically as described herein while leaving the cache allocation entities agnostic of cache allocation performance determination and operations.

At operation 412, the content system may initialize the cache resources for use with particular cache allocation entities as determined at one or more previous operations. For example, the content system may generate data indicating the cache resource allocations and associated cache allocation entities and may initialize parameter data that may be used to determine cache allocation performance data.

At operation 414, the content system may facilitate the processing of content requests, the storage of content transmitted from content providers, and/or the generation of cache allocation performance data. For example, the content system may receive content from content providers and store the content in the cache resources allocated to that provider. The content system may track the times and windows during which such content was downloaded to determine cache allocation performance data for the content providers (e.g., on an individual cache allocation entity basis). The content system may also detect and track requests for content as well as the results of such requests to determine cache allocation performance data. For instance, the content system may determine whether requested content was served to a user from the local cache resources and, if so, indicate that access as a successful cache access (“hit”) for the cache allocation entity associated with those local cache resources.

At operation 416, the content system may determine whether one or more cache allocation adjustment criteria have been met. Such criteria may be used to determine when the content system may evaluate current cache allocation performance data to determine whether to update cache allocation parameters. Such criteria may be a period of time since initializing the cache allocation parameter and/or since the most recent cache allocation parameter update (e.g., an hour, a day, a week, etc.). Cache allocation adjustment criteria may also, or instead, include other factors, such as a level of use of cache resources (e.g., update cache allocation parameter when the available cache resources have reached a threshold capacity (e.g., 50%, 75%, 95%, etc.)), detection of the creation of a new cache allocation entity (e.g., a new account is added for a provider; a new provider added, etc.), detection of the removal of a cache allocation entity (e.g., an account is deleted for a provider; a provider is deleted, etc.), and/or any other criteria that may be suitable for triggering a reevaluation and update of cache allocation parameters.

If the cache allocation adjustment criteria are not satisfied, the process 400 resumes servicing content requests and storing content at operation 414. If the cache allocation adjustment criteria are met, at operation 418, the content system may determine cache allocation performance data.

For example, at operation 420, the content system may determine a cache access rate or hit rate for one or more of the cache allocation entities (e.g., for a time period, such as since the initialization of the cache allocation parameters and/or since the previous update of cache allocation parameters). As described herein, this may be a ratio of content accessed from the cache resources for a particular cache allocation entity to a total number of content requests; however, other forms of measuring and/or determining a cache access rate for a cache allocation entity may also, or instead, be used.

Further as part of operation 418, at operation 422 a download window usage rate for one or more of the cache allocation entities may be determined (e.g., for a time period, such as since the initialization of the cache allocation parameters and/or since the previous update of cache allocation parameters). As described herein, this may be a ratio of the download times for content associated with a particular cache allocation entity that occurred during the preferred download window period for that entity to the total download time for the cached content associated with that entity; however, other forms of measuring and/or determining a download window usage rate for a cache allocation entity may also, or instead, be used.

Also as part of operation 418, at operation 424 a download deadline success rate for one or more of the cache allocation entities may be determined (e.g., for a time period, such as since the initialization of the cache allocation parameters and/or since the previous update of cache allocation parameters). As described herein, this may be a ratio of a number of downloads of content associated with a particular cache allocation entity completed before the download deadline for that entity to the total number of downloads associated with that entity; however, other forms of measuring and/or determining a download deadline success rate for a cache allocation entity may also, or instead, be used.

Referring now to FIG. 4B, at operation 426, a cache allocation factor may be determined for individual cache allocation entities based on the cache allocation performance data determined at operation 418. As described herein, this may be determined by averaging the values determined as cache allocation performance data and/or by using any other means or techniques for determining a cache allocation factor for a cache allocation entity. Such techniques may include weighting one or more cache allocation performance metrics based on some criteria to affect a significance of such metrics in the cache allocation factor determination.

At operation 428, the content system may determine updated cache allocation parameters and other cache allocation data based on the cache allocation factors determined for one or more cache allocation entities. For instance, at operation 430, the content system may determine updated cache allocations for such one or more cache allocation entities. At operation 432, the content system may determine one or more updated preferred download windows for one or more cache allocation entities. At operation 434, the content system may determine one or more updated download deadline for one or more cache allocation entities. In some examples, some cache allocation parameters may be adjusted while others may not. For instance, the content system may adjust the cache allocations for one or more cache allocation entities based on determined cache allocation factors while maintaining download deadlines and/or download windows for such entities.

At operation 436, the content system may transmit (e.g., via an API configured for such communications and/or using any other suitable means of communication) one or more cache resources “offers” or requests to one or more cache allocation entities based on the updated cache allocation parameters and data determined at operation 428. In examples, such an offer may take the form of a request for predicted content transmitted to a particular cache allocation entity as described herein. As noted above, in examples, the content system may or may not await confirmation from a cache allocation entity before allocating cache resources to the entity and/or performing other cache allocation operations.

At operation 438, the content system may configure (e.g., update) the cache resources for use with particular cache allocation entities as determined at one or more previous operations. For example, the content system may generate data indicating the updated cache resource allocations and associated cache allocation entities and may update or reset parameter data that may be used to determine cache allocation performance data. The process 400 may then return to operation 414 (see FIG. 4A), where the content system may facilitate the processing of content requests, the storage of content transmitted from content providers, and/or the generation of cache allocation performance data.

Note that any of the operations performed in the process 400 may be combined, along with any other operations or functions described herein. Any combinations of operations are contemplated as within the scope of the instant disclosure.

In summary, by more efficiently allocating local cache resources and incentivizing usage of network resources at outside of peak times, the disclosed systems and techniques may be able to increase the efficiency of usage of network resources and premises resources and improve the performance of both the network and user devices, especially for high bandwidth content consumption.

### Example User Equipment

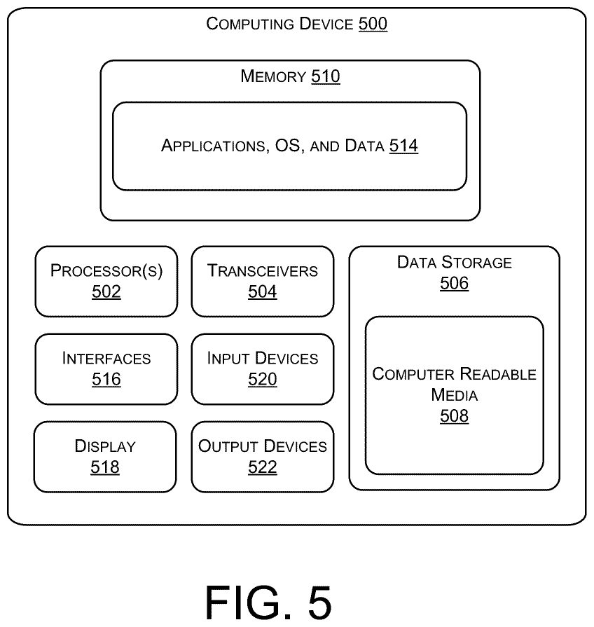

FIG. 5 is an example of a computing device 500, such as premises terminals 112, 122, and 201, for use with the systems and methods disclosed herein, in accordance with some examples of the present disclosure. The UE device 500 may include one or more processors 502, one or more transmit/receive antennas (e.g., transceivers or transceiver antennas) 504, and a data storage 506. The data storage 506 may include a computer-readable media 508 in the form of memory and/or cache. This computer-readable media may include a non-transitory computer-readable media. The processor(s) 502 may be configured to execute instructions, which can be stored in the computer-readable media 508 and/or in other computer-readable media accessible to the processor(s) 502. In some configurations, the processor(s) 502 is a Central Processing Unit (CPU), a Graphics Processing Unit (GPU), or both CPU and GPU, or any other sort of processing unit. The transceiver antenna(s) 504 can exchange signals with a base station, such as an eNodeB and a gNodeB or a WiFi router or hub.

The device 500 may be configured with a memory 510. The memory 510 may be implemented within, or separate from, the data storage 506 and/or the computer-readable media 508. The memory 510 may include any available physical media accessible by a computing device to implement the instructions stored thereon. For example, the memory 510 may include, but is not limited to, RAM, ROM, EEPROM, a SIM card, flash memory or other memory technology, CD-ROM, DVD or other optical disk storage, magnetic cassettes, magnetic tape, magnetic disk storage or other magnetic storage devices, or any other medium which may be used to store the desired information and which may be accessed by the device 500.

The memory 510 can store several modules, such as instructions, data stores, and so forth that are configured to execute on the processor(s) 502. In configurations, the memory 510 may also store one or more applications 514 configured to receive and/or provide voice, data and messages (e.g., SMS messages, Multi-Media Message Service (MMS) messages, Instant Messaging (IM) messages, Enhanced Message Service (EMS) messages, etc.) to and/or from another device or component (e.g., eNodeB, gNodeB, WiFi router, etc.). The applications 514 may also include one or more operating systems and/or one or more third-party applications that provide additional functionality to the device 500. The memory may also, or instead, store QoS information, bandwidth information, cache allocation information, cache allocation performance data, etc. The memory may also, or instead, store content and content information.

Although not all illustrated in FIG. 5, the computing device 500 may also comprise various other components, e.g., a battery, a charging unit, one or more network interfaces 516, an audio interface, a display 518, a keypad or keyboard, and one or more input devices 520, and one or more output devices 522.

### Example Computing Device

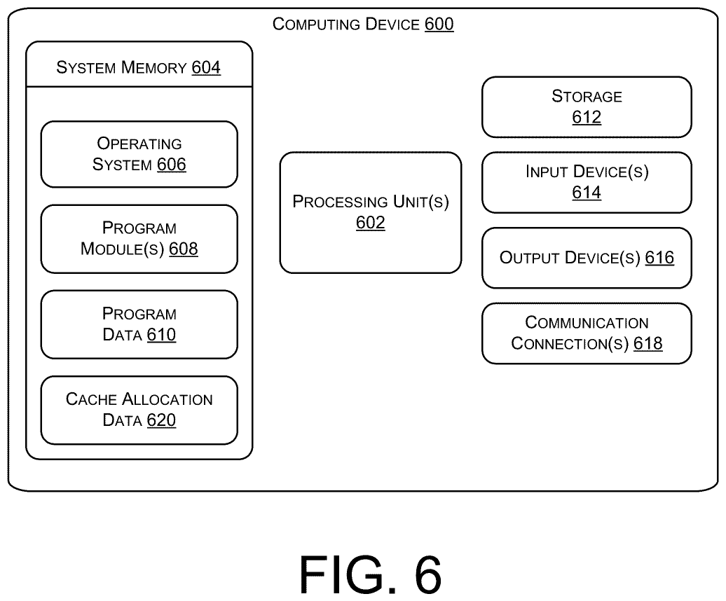

FIG. 6 is an example of a computing device 600 for use with the systems and methods disclosed herein, in accordance with some examples of the present disclosure. The computing device 600 can be used to implement various components of a network, a premises device (e.g., premises terminal 112, 122, 201), any one or more components in a wireless communications network, any one or more user devices (e.g., user device(s) 110, 120, 260), and/or any servers, routers, gateways, gateway elements, administrative components, etc. that can be used by a communication provider and/or a content provider. One or more computing devices 600 can be used to implement the network 101, for example. One or more computing devices 600 can also be used to implement base stations and other components.

In various embodiments, the computing device 600 can include one or more processing units 602 and system memory 604. Depending on the exact configuration and type of computing device, the system memory 604 can be volatile (such as RAM), nonvolatile (such as ROM, flash memory, etc.) or some combination of the two. The system memory 604 can include an operating system 606, one or more program modules 608, program data 610, and cache allocation data 620. The system memory 604 may be secure storage or at least a portion of the system memory 604 can include secure storage. The secure storage can prevent unauthorized access to data stored in the secure storage. For example, data stored in the secure storage can be encrypted or accessed via a security key and/or password.

The computing device 600 can also include additional data storage devices (removable and/or non-removable) such as, for example, magnetic disks, optical disks, or tape. Such additional storage is illustrated in FIG. 6 by storage 612.

The computing device 600 may store, in either or both of the system memory 604 and the storage 612, cache allocation data, cache allocation performance data, content, content information, content data, etc.

Non-transitory computer storage media of the computing device 600 can include volatile and nonvolatile, removable and non-removable media implemented in any method or technology for storage of information, such as computer-readable instructions, data structures, program modules, or other data. The system memory 604 and storage 612 are examples of computer-readable storage media. Non-transitory computer-readable storage media includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other medium which can be used to store the desired information and which can be accessed by computing device 600. Any such non-transitory computer-readable storage media can be part of the computing device 600.

In various embodiments, any or all of the system memory 604 and storage 612 can store programming instructions which, when executed, implement some or all of the functionality described above as being implemented by one or more systems configured in the environment 100 and/or components of the network 101, functions illustrated in the diagrams 200 and 270, and/or functions illustrated in the diagram 400.

The computing device 600 can also have one or more input devices 614, such as a keyboard, a mouse, a touch-sensitive display, voice input device, etc. The computing device 600 can also have one or more output devices 616 such as a display, speakers, a printer, etc. can also be included. The computing device 600 can also contain one or more communication connections 618 that allow the device to communicate with other computing devices using wired and/or wireless communications.

### Example Clauses

The following paragraphs describe various examples. Any of the examples in this section may be used with any other of the examples in this section and/or any of the other examples or embodiments described herein.
A: A method performed allocating cache resources at a terminal device, the method comprising: determining, by a content system configured at the terminal device, a first cache resource allocation of cache resources of the terminal device for a first cache allocation entity; determining, by the content system, a second cache resource allocation of the cache resources of the terminal device for a second cache allocation entity; storing, by the terminal device, first content associated with the first cache allocation entity at the first cache resource allocation; storing, by the terminal device, second content associated with the second cache allocation entity at the second cache resource allocation; processing, by the terminal device, a plurality of requests for content received from a user device; determining, by the content system, a first cache access rate for the first cache resource allocation based at least in part on the plurality of requests for content and the first content; determining, by the content system, a second cache access rate for the second cache resource allocation based at least in part on the plurality of requests for content and the second content; modifying, by the content system, the first cache resource allocation based at least in part on the first cache access rate; and modifying, by the content system, the second cache resource allocation based at least in part on the second cache access rate.
B: The method of paragraph A, wherein modifying the first cache resource allocation based at least in part on the first cache access rate comprises modifying the first cache resource allocation further based at least in part on additional cache performance data.
C: The method of paragraph B, wherein the additional cache performance data comprises one or more of a download window usage rate for the first cache allocation entity or a download deadline success rate for the first cache allocation entity.
D: The method of paragraph B or C, wherein modifying the first cache resource allocation based at least in part on the first cache access rate and the additional cache performance data comprises: determining a cache allocation factor based at least in part on the first cache access rate and the additional cache performance data; and modifying the first cache resource allocation based at least in part on the cache allocation factor.
E: The method of paragraph D, wherein determining the cache allocation factor comprises averaging a value representing the first cache access rate and one or more values representing the additional cache performance data.
F: The method of any of paragraphs A-E, wherein: the method further comprises determining that a cache allocation adjustment criterion has been met; determining the first cache access rate is further based at least in part on determining that the cache allocation adjustment criterion has been met; and determining the second cache access rate is further based at least in part on determining that the cache allocation adjustment criterion has been met.
G: The method of paragraph F, wherein the cache allocation adjustment criterion comprises one or more of: an expiration of a time period; a detection of an addition of a third cache allocation entity; or a detection of a deletion of at least one of the first cache allocation entity or the second cache allocation entity.
H: The method of any of paragraphs A-G, wherein at least one of the first cache allocation entity or the second cache allocation entity is associated with: a content provider; or a combination of a content provider and a user account.
I: A terminal device configured to communicate with a network, the terminal device comprising: one or more processors; one or more transceivers; and non-transitory computer-readable media storing computer-executable instructions that, when executed by the one or more processors, cause the one or more processors to execute a content system to perform operations comprising: allocating cache resources at the terminal device to a cache allocation entity based at least in part on one or more cache allocation parameters; storing content associated with the cache allocation entity at the cache resources; processing a plurality of requests for content received at the terminal device from a user device; determining cache performance data for the cache allocation entity based at least in part on the plurality of requests for content and the content; determining a cache allocation factor for the cache allocation entity based at least in part on the cache performance data; and modifying the cache resources allocated at the terminal device to the cache allocation entity based at least in part on the cache allocation factor.
J: The terminal device of paragraph I, further comprising transmitting a request for content to the cache allocation entity, the request for content comprising data representing at least a subset of the one or more cache allocation parameters.
K: The terminal device of paragraph I or J, wherein the cache performance data comprises at least one of: a cache access rate for the cache resources allocated to the cache allocation entity; a download window usage rate for the cache allocation entity; or a download deadline success rate for the cache allocation entity.
L: The terminal device of any of paragraphs I-K, wherein the one or more cache allocation parameters comprise at least one of: an allocation of cache resources; a download window; or a download deadline.
M: The terminal device of paragraph L, wherein: the one or more cache allocation parameters comprise the download window; and the download window is based at least in part on network utilization at the network.
N: The terminal device of paragraph M, wherein: the one or more cache allocation parameters comprise the download deadline; and the download deadline is based at least in part on a user's content consumption history.
O: A non-transitory computer-readable media storing computer-executable instructions that, when executed by one or more processors, cause the one or more processors to perform operations comprising: allocating cache resources at a terminal device to a cache allocation entity based at least in part on one or more cache allocation parameters; storing content associated with the cache allocation entity at the cache resources; processing a plurality of requests for content received at the terminal device from a user device; determining cache performance data for the cache allocation entity based at least in part on the plurality of requests for content and the content; determining a cache allocation factor for the cache allocation entity based at least in part on the cache performance data; and modifying the cache resources allocated at the terminal device to the cache allocation entity based at least in part on the cache allocation factor.
P: The non-transitory computer-readable media of paragraph O, wherein allocating the cache resources at the terminal device comprises: transmitting the one or more cache allocation parameters to the cache allocation entity; receiving a response from the cache allocation entity; and allocating the cache resources at the terminal device further based at least in part on the response.
Q: The non-transitory computer-readable media of paragraph O or P, wherein: the operations further comprise determining that a cache allocation adjustment criterion has been met; and determining the cache performance data for the cache allocation entity is further based at least in part on determining that the cache allocation adjustment criterion has been met.
R: The non-transitory computer-readable media of paragraph Q, wherein the cache allocation adjustment criterion comprises one or more of: an expiration of a time period; a detection of an addition of a second cache allocation entity; or a detection of a deletion of the cache allocation entity.
S: The non-transitory computer-readable media of any of paragraphs O-R, wherein the cache performance data is based at least in part on a ratio of a number of requests for content of the plurality of requests that are served from cache resources allocated to the cache allocation entity to a total quantity of the plurality of requests.
T: The non-transitory computer-readable media of any of paragraphs O-T, wherein the cache allocation entity is associated with a content provider or a combination of a content provider and a user account.

While the example clauses described above are described with respect to one particular implementation, it should be understood that, in the context of this document, the content of the example clauses can also be implemented via a method, device, system, computer-readable medium, and/or another implementation. Additionally, any of the examples A-T can be implemented alone or in combination with any other one or more of the examples A-T.

### CONCLUSION

Depending on the embodiment, certain operations, acts, events, or functions of any of the algorithms described herein can be performed in a different sequence, can be added, merged, or left out altogether (e.g., not all described acts or events are necessary for the practice of the algorithm). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, components, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks, modules, and components described in connection with the embodiments disclosed herein can be implemented or performed by a machine, such as a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The elements of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium known in the art. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements, and/or states. Thus, such conditional language is not generally intended to imply that features, elements, and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” “involving,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Unless otherwise explicitly stated, articles such as “a” or “the” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others. The scope of certain inventions disclosed herein is indicated by the appended claims rather than by the foregoing description. All changes which come within the meaning and range of equivalency of the claims are to be embraced within their scope.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A method performed allocating cache resources at a terminal device, the method comprising:
determining, by a content system configured at the terminal device, a first cache resource allocation of cache resources of the terminal device for a first cache allocation entity;
determining, by the content system, a second cache resource allocation of the cache resources of the terminal device for a second cache allocation entity;
storing, by the terminal device, first content associated with the first cache allocation entity at the first cache resource allocation;
storing, by the terminal device, second content associated with the second cache allocation entity at the second cache resource allocation;
processing, by the terminal device, a plurality of requests for content received from a user device;
determining, by the content system, a first cache access rate for the first cache resource allocation based at least in part on the plurality of requests for content and the first content;
determining, by the content system, a second cache access rate for the second cache resource allocation based at least in part on the plurality of requests for content and the second content;
modifying, by the content system, the first cache resource allocation based at least in part on the first cache access rate; and
modifying, by the content system, the second cache resource allocation based at least in part on the second cache access rate.

2. The method of claim 1, wherein modifying the first cache resource allocation based at least in part on the first cache access rate comprises modifying the first cache resource allocation further based at least in part on additional cache performance data.

3. The method of claim 2, wherein the additional cache performance data comprises one or more of a download window usage rate for the first cache allocation entity or a download deadline success rate for the first cache allocation entity.

4. The method of claim 2, wherein modifying the first cache resource allocation based at least in part on the first cache access rate and the additional cache performance data comprises:
determining a cache allocation factor based at least in part on the first cache access rate and the additional cache performance data; and
modifying the first cache resource allocation based at least in part on the cache allocation factor.

5. The method of claim 4, wherein determining the cache allocation factor comprises averaging a value representing the first cache access rate and one or more values representing the additional cache performance data.

6. The method of claim 1, wherein:
the method further comprises determining that a cache allocation adjustment criterion has been met;
determining the first cache access rate is further based at least in part on determining that the cache allocation adjustment criterion has been met; and
determining the second cache access rate is further based at least in part on determining that the cache allocation adjustment criterion has been met.

7. The method of claim 6, wherein the cache allocation adjustment criterion comprises one or more of:
an expiration of a time period;
a detection of an addition of a third cache allocation entity; or
a detection of a deletion of at least one of the first cache allocation entity or the second cache allocation entity.

8. The method of claim 1, wherein at least one of the first cache allocation entity or the second cache allocation entity is associated with:
a content provider; or
a combination of a content provider and a user account.

9. A terminal device configured to communicate with a network, the terminal device comprising:
one or more processors;
one or more transceivers; and
non-transitory computer-readable media storing computer-executable instructions that, when executed by the one or more processors, cause the one or more processors to execute a content system to perform operations comprising:
allocating cache resources at the terminal device to a cache allocation entity based at least in part on one or more cache allocation parameters;
storing content associated with the cache allocation entity at the cache resources;
processing a plurality of requests for content received at the terminal device from a user device;
determining cache performance data for the cache allocation entity based at least in part on the plurality of requests for content and the content;
determining a cache allocation factor for the cache allocation entity based at least in part on the cache performance data; and
modifying the cache resources allocated at the terminal device to the cache allocation entity based at least in part on the cache allocation factor.

10. The terminal device of claim 9, further comprising transmitting a request for content to the cache allocation entity, the request for content comprising data representing at least a subset of the one or more cache allocation parameters.

11. The terminal device of claim 9, wherein the cache performance data comprises at least one of:
a cache access rate for the cache resources allocated to the cache allocation entity;
a download window usage rate for the cache allocation entity; or
a download deadline success rate for the cache allocation entity.

12. The terminal device of claim 9, wherein the one or more cache allocation parameters comprise at least one of:
an allocation of cache resources;
a download window; or
a download deadline.

13. The terminal device of claim 12, wherein:
the one or more cache allocation parameters comprise the download window; and
the download window is based at least in part on network utilization at the network.

14. The terminal device of claim 12, wherein:
the one or more cache allocation parameters comprise the download deadline; and
the download deadline is based at least in part on a user's content consumption history.

15. A non-transitory computer-readable media storing computer-executable instructions that, when executed by one or more processors, cause the one or more processors to perform operations comprising:
allocating cache resources at a terminal device to a cache allocation entity based at least in part on one or more cache allocation parameters;
storing content associated with the cache allocation entity at the cache resources;
processing a plurality of requests for content received at the terminal device from a user device;
determining cache performance data for the cache allocation entity based at least in part on the plurality of requests for content and the content;
determining a cache allocation factor for the cache allocation entity based at least in part on the cache performance data; and
modifying the cache resources allocated at the terminal device to the cache allocation entity based at least in part on the cache allocation factor.

16. The non-transitory computer-readable media of claim 15, wherein allocating the cache resources at the terminal device comprises:
transmitting the one or more cache allocation parameters to the cache allocation entity;
receiving a response from the cache allocation entity; and
allocating the cache resources at the terminal device further based at least in part on the response.

17. The non-transitory computer-readable media of claim 15, wherein:
the operations further comprise determining that a cache allocation adjustment criterion has been met; and
determining the cache performance data for the cache allocation entity is further based at least in part on determining that the cache allocation adjustment criterion has been met.

18. The non-transitory computer-readable media of claim 17, wherein the cache allocation adjustment criterion comprises one or more of:
an expiration of a time period;
a detection of an addition of a second cache allocation entity; or
a detection of a deletion of the cache allocation entity.

19. The non-transitory computer-readable media of claim 15, wherein the cache performance data is based at least in part on a ratio of a number of requests for content of the plurality of requests that are served from cache resources allocated to the cache allocation entity to a total quantity of the plurality of requests.

20. The non-transitory computer-readable media of claim 15, wherein the cache allocation entity is associated with a content provider or a combination of a content provider and a user account.
